(19) United States
(12) Patent Application Publication
(10) Pub. No.: US 2008/0089661 A1
(43) Pub. Date: Apr. 17, 2008

(54) Information recording/reproducing apparatus

(75) Inventor: Teruyuki Yamagishi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/898,751

(22) Filed: Sep. 14, 2007

(30) Foreign Application Priority Data
Oct. 12, 2006 (JP) 2006-278319

(51) Int. Cl. H04N 5/91

(52) U.S. Cl. 386/68; 386/95

(57) ABSTRACT

In the event that a chapter setting mode is effective, for example, when pausing takes place at a time (t1) during reproduction, a chapter (c1) is set to the location of the pause. When a commercial then appears at a time (t2) and a skip commercial operation takes place, a chapter (c2) is set to the location where the skipping starts. When the commercial skipping then ends at a time (t3), a chapter (c3) is set to the location where the skipping ends. When a fast forward operation takes place during reproduction at a time (t4), a chapter (c4) is set to the location where fast forwarding starts. When a fast reverse operation occurs at a time (t5) and fast reversing takes place, a chapter (c5) passed through during the fast reversing is deleted. When an operation to stop fast reversing then takes place, a chapter (c6) is set to the location where fast reversing ends.

This application is based on Japanese Patent Application No. 2006-278319 filed on Oct. 12, 2006, the contents of which are hereby incorporated by reference.

### BACKGROUND OF THE INVENTION

1. Field of the Invention

The present invention relates to information recording/reproducing apparatus such as a DVD recorder, a hard disk recorder, or a combination apparatus incorporating a DVD recorder and a hard disk recorder, and particularly relates to processing for setting chapters.

2. Description of Related Art

In recent years, remarkable progress has been made in technology for putting picture information and audio information into the form of digital data and compressing the resulting data. As a result, information recording/reproducing apparatus such as DVD recorders that record/reproduce picture and audio information to/from an optical disc such as a DVD (Digital Versatile Disc), hard disk recorders that record/reproduce picture and audio information to/from a hard disk, and combination apparatus incorporating both a DVD recorder and a hard disk recorder have become widespread, taking over from VCRs (Video Cassette Recorders) that record/reproduce picture and audio information to/from magnetic tape.

The use of a title search, a chapter search, or a time search is common when desired information is rapidly searched and reproduced from an optical disc or a hard disk. For example, when picture and audio information recorded on an optical disc is reproduced, when a title search, a chapter search, or a time search is carried out, first, the optical disc to be reproduced is inserted into an information recording/reproducing apparatus. A menu key of a remote control unit is then pressed down and a mode of either a title search, a chapter search, or a time search is selected from menu items on a menu screen displayed at the display apparatus as a result of pressing down a direction key of the remote control unit. When a decision is then made by pressing down a decide key, the apparatus is set to either title search, chapter search, or time search mode.

It is necessary for tit1es to be divided up in advance in order to carry out a chapter search even during this type of search. With information recording/reproducing apparatus of the related art, the user therefore makes chapters using, for example, the following procedure.

First, after the optical disc is inserted in the apparatus, a reproduction key of the remote control unit is pressed down and reproduction of optical disc information is commenced. When it is wished to set a chapter during reproduction, a pause key is pressed down and reproduction is paused. A chapter key is then pressed down and a chapter is set. Next, the pause key is pressed again, pausing is released, and reproduction commences. When a commercial appears during reproduction, this commercial becomes bound in with the chapter. The pause key is therefore pressed at the time when the commercial appears so that reproduction is paused, the chapter key is then pressed, and a chapter is set to the location of the start of the commercial. The pause key is then pressed down again, and reproduction is commenced. When the location of the end of the commercial is reached, the pause key is pressed down again, reproduction is paused, the chapter key is pressed down again, and a chapter is set to the location of the end of the commercial. After this, the pause button is then similarly pressed down and reproduction is commenced. Further, during reproduction, a fast forward key is pressed down so as to fast forward up to the target picture it is wished to set a chapter at. Pausing then takes place as a result of pressing down the pause key at this target picture. The chapter key is then pressed down and a chapter is set at this target picture. Further, if the target picture is gone past during fast forwarding, a fast reverse key is pressed down, the target picture is returned to, and pausing takes place as a result of pressing down the pause key. The chapter may then be set to the target picture by pressing down the chapter key.

In the above description, with information recording/reproducing apparatus of the related art, a user presses a reproduction key, a pause key, a fast forward key, a fast reverse key, or a skip commercial key etc. in order to reach a target picture it is wished to set a chapter to. It is therefore necessary to keep operating the chapter key a number of times in order to set the chapter at the start location and end location of pictures it is wished to set the chapters to, which makes the chapter setting operation troublesome. Further, a chapter may be created needlessly if an erroneous chapter setting operation takes place.

In technology of the related art of JP-A-2002-152636 and JP-A-2004-364325, pausing takes place during recording. A position where recording is re-started is then taken as a boundary for a chapter, with the chapters being made automatically. However, this chapter setting does not take place during reproduction. Further, in the related art, for example, chapter setting is carried out by operating a dividing button during forward and reverse reproduction of constant speed. However, the chapters are not made automatically using operations taking place during viewing by a user and the operation relating to chapter setting is therefore troublesome.

Technology of the related art of JP-A-2003-16764 is provided with an edit function capable of making reproduction smooth based on program chain information of an arbitrary play list. Here, for example, when continuity of neighboring chapters is confirmed, processing to make these chapters one is implemented so as to combine the chapters. However, this related art technology is also not the result of chapters being automatically made as a result of operations while a user is viewing and the chapter setting operation is therefore troublesome.

### SUMMARY OF THE INVENTION

The present invention sets out to resolve the problems described above and it is therefore the object of the present invention to provide an information recording/reproducing apparatus capable of automatically making chapters as a result of key operations of a user during viewing, capable of making chapters a single chapter when consecutive fast forwarding or commercial skipping is carried out, and capable of deleting chapter settings up to a location that is returned to when fast reversing is performed after fast forwarding or commercial skipping.

In order to achieve this object, an information recording/reproducing apparatus has a tuner for receiving and selecting a television broadcast signal, records programs selected using the tuner or other information to a recording medium, and has a chapter setting mode. The information recording/reproducing apparatus records set chapter information to the recording medium or internally within the apparatus and reproduces information recorded on the recording medium. This information recording/reproducing apparatus comprises a system controller that includes: a chapter setting section for setting a chapter to a location corresponding to a time of changing of an operating state of the recording medium as a result of a user operation during reproduction of information recorded on the recording medium when the chapter setting mode is effective; a fast reverse chapter deleting section for deleting chapters passed through in fast reverse; and a fast reverse chapter setting section for setting a chapter to a fast reverse end location.

According to this configuration, in the event that chapter setting mode is set, it is possible to automatically set chapters for information recorded on a recording medium according to operations (operations such as pausing, reproducing, stopping, commercial skipping, fast forwarding, and fast reversing) by a user (viewer) during viewing and it is possible to delete chapters passed through during a fast reverse operation. It is therefore possible for chapters to be set in an unconscious manner in line with what the users themselves see as appropriate as a result of operating in unison with user operations. This means that unnecessary chapters are not generated and that ease of use is improved.

Further, the information recording/reproducing apparatus of the present invention comprises a system controller that includes: a chapter setting section for setting a chapter to a location corresponding to a time of changing of an operating state of a recording medium as a result of a user operation during reproduction of information recorded on the recording medium when the chapter setting mode is effective; and a chapter deleting section for, when it is determined that reproduction time between a chapter set to a fast forward end location or a skip commercial end location and a chapter set to a next fast forward start location or a next skip commercial start location is shorter than a predetermined time, deleting both of the chapters.

According to this configuration, in the event that chapter setting mode is set, it is possible to automatically make chapters for information recorded on a recording medium according to operations (operations such as pausing, reproducing, stopping, commercial skipping, fast forwarding, and fast reversing) by a user (viewer) during viewing. When a fast forward operation or a skip commercial operation are carried out consecutively, it is also possible to link these sections together as one chapter. It is therefore possible for chapters to be set subconsciously in line with what the users themselves see as appropriate through operation in cooperation with user operations. Being able to make sections of consecutive fast forward operations or skip commercial operations a single chapter also means that unnecessary chapters are not created and improves ease of use.

Further, the information recording/reproducing apparatus of the present invention comprises a system controller that includes: a chapter setting section for setting a chapter to a location corresponding to a time of changing of an operating state of a recording medium as a result of a user operation during reproduction of information recorded on the recording medium when the chapter setting mode is effective; a chapter deleting section for, when it is determined that reproduction time between a chapter set to a fast forward end location or a skip commercial end location and a chapter set to a next fast forward start location or a next skip commercial start location is shorter than a predetermined time, deleting both of the chapters; a fast reverse chapter deleting section for, when fast reversing is carried out, deleting chapters passed through during the fast reversing; and a fast reverse chapter setting section for setting a chapter to a fast reverse end location.

According to this configuration, in the event that chapter setting mode is set, it is possible to automatically set chapters for information (moving pictures) recorded on a recording medium according to operations (operations such as pausing, reproducing, stopping, commercial skipping, fast forwarding, and fast reversing) performed by a user (viewer) during viewing. Further, when a fast forward operation or a skip commercial operation are consecutive, these sections are joined together to give one chapter. When fast reversing is carried out after fast forwarding and commercial skipping, it is possible to erase chapter settings for up to the location that is reversed to. It is therefore possible for chapters to be set subconsciously in line with what the users themselves see as appropriate through operation in cooperation with user operations. It is also possible to make sections where fast forward operations or skip commercial operations are carried out consecutively into a single chapter. This means that it is easy to skip commercials completely at the time of the next viewing, chapter setting positions can be reliably set, unnecessary chapters are not created, and ease of use is improved.

### BRIEF DESCRIPTION OF THE DRAWINGS

FIG. 1 is a block view showing a configuration for an information recording/reproducing apparatus of a first, a second, and a third embodiment of the present invention;

FIG. 2 is a timing diagram illustrating chapter setting processing of the first embodiment;

FIG. 3 is a flowchart illustrating chapter setting processing of the first embodiment;

FIG. 4 is a timing diagram illustrating chapter setting processing of the second embodiment;

FIG. 5 is a flowchart illustrating chapter setting processing of the second embodiment;

FIG. 6 is a timing diagram illustrating chapter setting processing of the third embodiment; and

FIG. 7 is a flowchart illustrating chapter setting processing of the third embodiment.

### DETAILED DESCRIPTION OF PREFERRED EMBODIMENTS

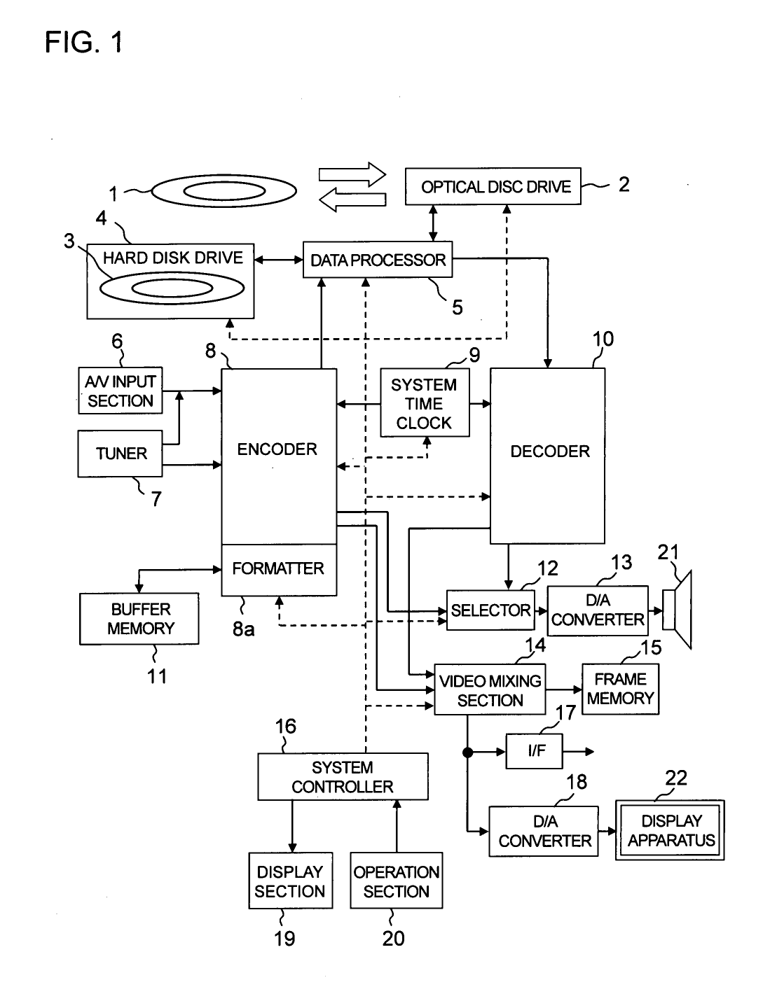

Hereinafter, the embodiments of the present invention will be described, with reference to the accompanying drawings. FIG. 1 is a block view showing a configuration for information recording/reproducing apparatus of a first, a second, and a third embodiment of the present invention. A description is given here of a configuration for combination-type information recording/reproducing apparatus equipped with an optical disc and a hard disk as recoding media. However, the same chapter setting processing can also be adopted for information recording/reproducing apparatus (DVD recorders) equipped only with an optical disc as a recording media or for information recording/reproducing apparatus (hard disk recorder) equipped with only a hard disk as a recording medium.

In FIG. 1, this information recording/reproducing apparatus is provided with an optical disc drive 2, an HDD (Hard Disk Drive) 4, a data processor 5, an A/V input section 6, a tuner 7, an encoder 8, a system time clock 9, a decoder 10, a buffer memory 11, a selector 12, a D/A converter 13, a video mixing section 14, a frame memory 15, a system controller 16, an I/F (interface) 17, a D/A converter 18, a display section 19, and an operation section 20.

The optical disc drive 2 has a rotation control system for the optical disc 1, a laser drive system, and an optical system, etc., rotatably drives the optical disc 1 so that information such as picture information and audio information can be recorded and reproduced, and is capable of writing information to the optical disc 1 and reading information recorded on the optical disc 1. The HDD 4 drives a hard disk 3 that is capable of recording and playing back information such as picture information and audio information, writes information to the hard disk 3 and reads out information recorded on the hard disk 3. The data processor 5 handles recording or reproducing units of data, includes a buffer circuit, modulating/decoding circuit, and error correction section etc., and is capable of supplying recording data to the optical disc drive 2 and HDD 4. The data processor 5 is further capable of receiving reproduced signals.

The main elements of the configuration of this information recording/reproducing apparatus are the encoder 8 that is the recording side, the decoder 10 that is the reproducing side, and the system controller 16 implemented by a microcomputer etc. carrying out control of the apparatus as a whole. The encoder 8 has analog/digital converters for video use and audio use for putting an inputted analog video signal and analog audio signal into digital form, a video encoder, an audio encoder, and a sub-picture encoder.

An output signal of the encoder 8 is converted to a predetermined DVD format at a formatter 8a containing the buffer memory 11 and is supplied to the data processor 5. An external analog video signal and an external analog audio signal are inputted from the A/V input section 6 to the encoder 8. The encoder 8 can also supply a compressed digital video signal and digital audio signal directly to the formatter 8a when a directly compressed digital video signal or digital audio signal is inputted directly. Further, the encoder 8 can also supply a digital video signal or an audio signal that has been converted from analog to digital to the video mixing section 14 and the selector 12.

At the video encoder contained in the encoder 8, the digital video signal is converted to a digital video signal compressed at a variable bit rate based on the MPEG standard. The digital audio signal is converted to a digital audio signal compressed at a fixed bit rate or to a linear pulse code-modulated (PCM) digital audio signal based on the MPEG or AC-3 standard.

When a sub-picture signal is inputted from the A/V input section 6 (for example, when a signal from a DVD video player with an independent output terminal for a sub-picture signal etc. is inputted), or when a DVD video signal of this kind of data configuration is broadcast and then received by the tuner 7, a sub-picture signal in the DVD video signal is encoded (run-length encoding) by a sub-picture encoder to give a sub-picture bitmap.

The encoded digital video signal, digital audio signal, and sub-picture data are packed by the formatter 8a to give a video pack, an audio pack, and a sub-picture pack. The packs are then grouped together and converted to a format specified by a DVD recording standard (for example, a standard for recording DVD-R, DVD-RW, and DVD-RAM, etc.).

At this information recording/reproducing apparatus, information formatted by the formatter 8a (packs such as video, audio, and sub-picture data etc.) and produced management information are supplied to the HDD 4 or the optical disc drive 2 via the data processor 5 and can be recorded on the hard disk 3 or the optical disc 1. Further, information recorded on the hard disk 3 can also be recorded on the optical disc 1 via the data processor 5 and the optical disc drive 2, and information recorded on the optical disc 1 can also be recorded on the hard disk 3 via the data processor 5 and the HDD 4.

Of execution results of the system controller 16, content to be notified to the user is displayed at the display section 19 or is displayed as an on-screen display at the display apparatus 22. The system controller 16 executes control according to operation signals of various operation keys of the operation section 20 of the remote control unit etc. Further, timing the system controller 16 controls the optical drive 2, the HDD4, the data processor 5, the encoder 8, and/or the decoder 10 etc. with is executed based on a time clock from the system time clock 9. The operation of recording and reproduction is normally executed in synchronization with a time clock from the system time clock 9 but processing other than this may be executed at times that are independent from the time clock.

The decoder 10 is provided with: a separator having a buffer structure, for separating and extracting each pack from a DVD format signal; a memory used in pack separation and when other signal processing is executed; a video decoder that decodes main picture data (video pack contents) separated by the separator; a sub-picture decoder for decoding sub-picture data (sub-picture data pack contents) separated by the separator; and an audio decoder for decoding audio data (audio pack contents) separated by the separator. Further, the decoder 10 is provided with a video processor for appropriately synthesizing the decoded sub-picture at the decoded main picture, and superimposing menus, highlight buttons, subtitles, and other sub-pictures with the main picture for output.

An outputted video signal of the decoder 10 is then inputted to the video mixing section 14. Synthesis of text data is then carried out at the video mixing section 14. Further, a line for directly taking in signals from the tuner 7 and the A/V input section 6 is also connected to the video mixing section 14 (not shown). A frame memory 15 used as a buffer is also connected to the video mixing section 14. When the output signal of the video mixing section 14 is an analog signal, this signal is outputted to outside via the I/F (interface) 17. When the output signal of the video mixing section 14 is a digital signal, this signal is outputted to outside via the D/A (digital/analog) converter 18.

The outputted audio signal of the decoder 10 is then inputted to the D/A converter 13 via the selector 12, converted to an analog audio signal, and outputted to outside. The audio signal is also supplied to the speaker 21 via an audio circuit (not shown). The selector 12 is controlled by a select signal from the system controller 16. In this way, the selector 12 can directly select a signal bypassing the encoder 8 when directly monitoring the digital signal from the tuner 7 and the A/V input section 6.

At the formatter 8a of the encoder 8, each item of divided information is made during recording and is periodically sent to the system controller 16. Divided information is information such as the number of VOBU (Video Object Unit) packs, Ith picture end address from the top of the VOBU, and VOBU reproduction time.

Further, information from an aspect ratio information processor (not shown) is sent to the system controller 16 when recording starts. VOB stream information is then made at the system controller 16. The stream information (STI) has resolution data and aspect ratio data etc. The decoder 10 then undergoes initial setting based on the resolution data and aspect data etc. at the time of reproduction.

A minimum limit for consecutive information units (size) is decided in order to continue reproduction in an uninterrupted manner when accessing (seeking) data of the optical disc 1 and the hard disk 3. This unit is referred to as a CDA (Contiguous Data Area). The size of the CDA is a multiple of ECC (Error Correction Code) block (sixteen sectors), with recording being carried out in the file system in CDA units.

The data processor 5 receives VOBU units of data from the formatter 8a of the encoder 8 and supplies CDA units of data to the optical disc drive 2 or the HDD 4. Further, the system controller 16 makes management information necessary for reproducing recorded data. When a command for data recording completion is then recognized, the management information made is sent to the data processor 5. As a result, the management information is recorded on the optical disc 1 or the hard disk 3. When encoding is then carried out by the encoder 8, the system controller 16 receives information in data units from the encoder 8. Further, the system controller 16 recognizes management information (the file system) read from the optical disc 1 and the hard disk 3 at the time of starting recording. As a result, unrecorded areas of each disc are recognized and it is possible to write information to the unrecorded areas.

Chapter information set during chapter setting (described later) may be written as part of the management information to the optical disc 1 or the hard disk 3 when it is possible to do so, or may be recorded to the internal memory of the information recording/reproducing apparatus. In particular, in the case of a finalized optical disc 1 at the time of recording pictures, this kind of management information cannot be additionally written. It is therefore effective to provide a location for storing management information in the internal memory of the information recording/reproducing apparatus for writing chapter information. Further, a chapter setting section and a chapter deleting section described later are comprised of the system controller 16, a program causing the system controller 16 to operate, and elements necessary for the management of chapter information in the configuration described above.

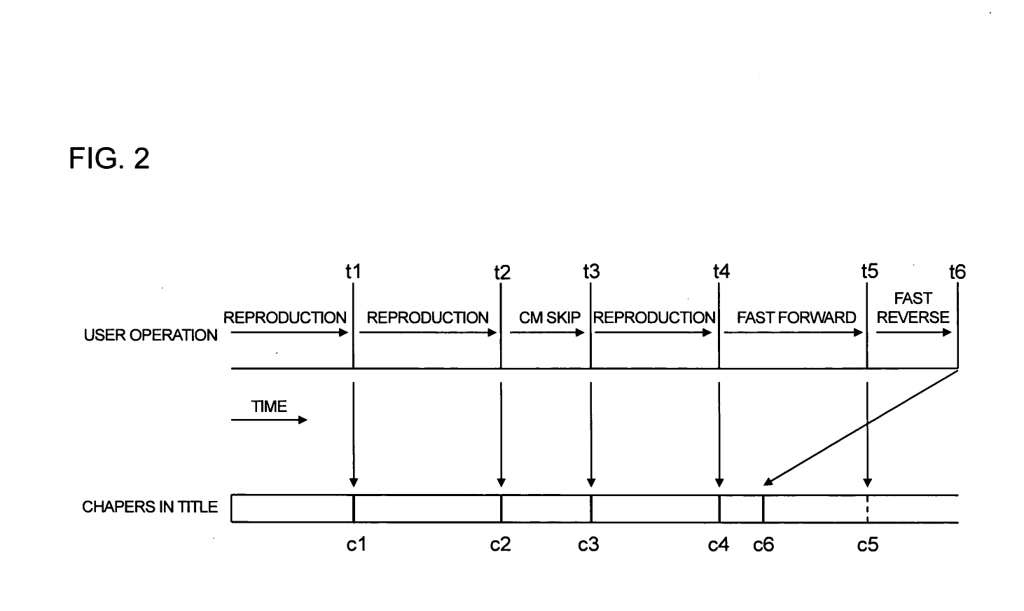

FIG. 2 is a timing diagram illustrating chapter setting processing of the first embodiment. A “user operation” chart indicates timing of user operations where a user operates the operation section, and a “chapters in the title” chart indicates the timing of chapters set within a title recorded to the optical disc or the hard disk.

In the “user operation” chart, t1 indicates the time where the pause key of the operation section 20 (refer to FIG. 1) is pressed down during reproduction. t2 indicates a time where the skip commercial key (for example, a 30-second skip key that skips ahead 30 seconds) of the operation section 20 is pressed during reproduction. t3 indicates an ending time of skipping executed as a result of pressing down of the skip commercial key. t4 indicates a time where a fast forward key of the operation section 20 is pressed down during reproduction. t5 indicates the time where the fast reverse key of the operation section 20 is pressed down during fast forwarding executed as a result of pressing down the fast forward key. t6 indicates a time where executed fast reversing ends.

At the chart for the “chapter in the title”, c1 indicates a chapter set at pause time T1, c2 indicates a chapter set at the commercial skip start time t2, c3 indicates a chapter set at skip end time t3, c4 indicates a chapter set at fast forward start time t4, c5 indicates a chapter set at fast forward end time t5, and c6 indicates a chapter set at fast reversing end time t6. In the case of this example, a chapter c5 that has been passed through is erased by the fast reverse operation between time t5 and time t6.

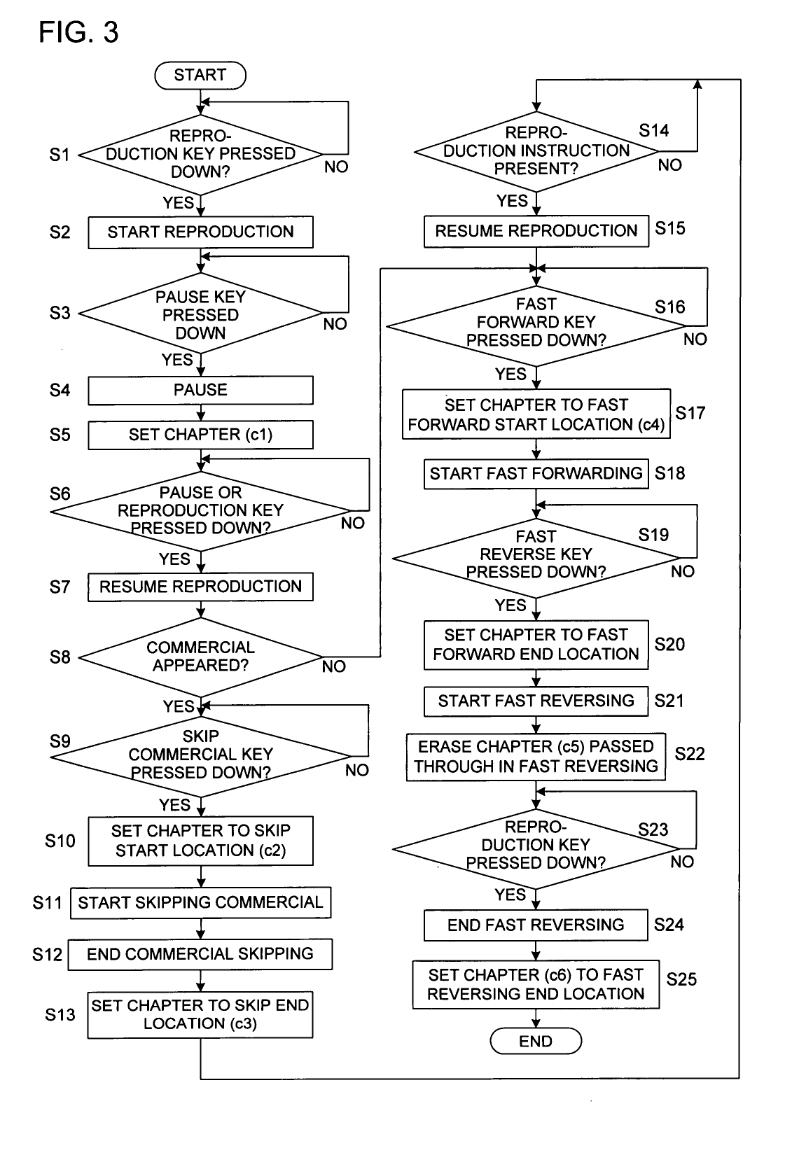

FIG. 3 is a flowchart illustrating chapter setting processing of the first embodiment. A description of a chapter setting process is now given with reference to this flowchart and to FIG. 1 and FIG. 2. A description is given here of processing for reproducing and setting chapters for information recorded on the optical disc 1. However, the same also applies for processing for reproducing and setting chapters for information recorded on the hard disk 3.

The system controller 16 of this first embodiment is provided with a first chapter setting section for, when there is a pause operation during reproduction of information recorded to a recording medium, setting a chapter to the pause location in the event that a chapter setting mode is effective, a second chapter setting section for setting a chapter to a skip start location when there is a commercial skip operation, a third chapter setting section for setting a chapter to a skip end location when the commercial skipping is complete, a fourth chapter setting section for setting a chapter to a fast forward start location at the time of a fast forward operation, a fifth chapter setting section for setting a chapter to a fast forward end location when an operation to halt fast forwarding is carried out, a fast reverse chapter deleting section for deleting chapter(s) passed through in fast reverse when fast reversing is carried out, and a fast reverse chapter setting section for setting a chapter to a fast reverse end location.

When the reproduction key of the operation section 20 is pressed down when the chapter setting mode is effective, the system controller 16 detects pressing down of the reproduction key (step S1). The optical disc drive 2 is then made to reproduce, and reproduction of the optical disc 1 is commenced (step S2). During this reproduction, when the pause key of the operation section 20 is pressed down, the system controller 16 detects pressing down of the pause key (step S3), pauses the optical disc drive 2, and sets the location of this temporary pause to chapter c1 using the first chapter setting section (step S5).

Next, when the pause key is pressed down again so that pausing is released, or when the reproduction key is pressed down, the system controller 16 detects pressing down of the pause key or pressing down of the reproduction key (step S6). The optical disc drive 2 is then made to reproduce, and reproduction (reproduction from time t1 to time t2) of information of the optical disc 1 is started again (step S7).

When a commercial appears during reproduction of information of the optical disc 1 (step S8), when the skip commercial key is pressed down at time t2, the system controller 16 detects the pressing down of the skip commercial key (step S9). Setting of chapter c2 to the location of the start of the skip is then carried out by the second chapter setting section (step S10). The system controller 16 then causes the optical disc drive 2 to perform a skip commercial operation, and skipping of the commercial is started (step S11). When skipping of the commercial is complete (step S12), the system controller 16 carries out setting of chapter c3 to the skip end location using the third chapter setting section (step S13).

The optical disc drive 2 is then instructed to reproduce by the system controller 16 (step S14) and reproduction restarts (step S15). During this reproduction (during reproduction from time t3), when the fast forward key of the operation section 20 is pressed down, the system controller 16 detects the pressing down of the fast forward key (step S16). Chapter c4 is then set to the location of the start of fast forward (step S17) by the fourth chapter setting section. The system controller 16 then causes the optical disc drive 2 to perform a fast forward operation, and fast forwarding is started for the optical disc 1 (step S18).

When an operation to halt the fast forward is carried out when this fast forward is executed, for example, in this case, if the fast reverse key is pressed down (step S19), the system controller 16 sets chapter c5 to the location of the end of the fast forwarding using the fifth chapter setting section (step S20), and fast reverse is started (step S21). The system controller 16 then deletes the chapter c5 passed through in fast reverse (step S22). When the system controller 16 then detects an operation to pause the fast reversing at time t6, for example, the system controller 16 detects the start of reproduction (step S23), the fast reverse is ended (step S24). Chapter c6 is then set to the end location of the fast reverse by the fast reverse chapter setting section (step S25).

According to this first embodiment, when the chapter setting mode is effective, it is possible to make chapters for information (moving pictures) recorded on recording media (the optical disc 1 or hard disk 3) automatically using operations (operations such as pausing, reproduction, stopping, commercial skipping, fast forward, fast reverse etc.) taking place during viewing by a user (viewer). Further, it is possible to delete chapters passed through by a fast reverse operation. It is therefore possible for chapters to be set in an unconscious manner in line with what the users themselves see as appropriate through operation in unison with user operations. This means that unnecessary chapters are not generated and that ease of use is improved.

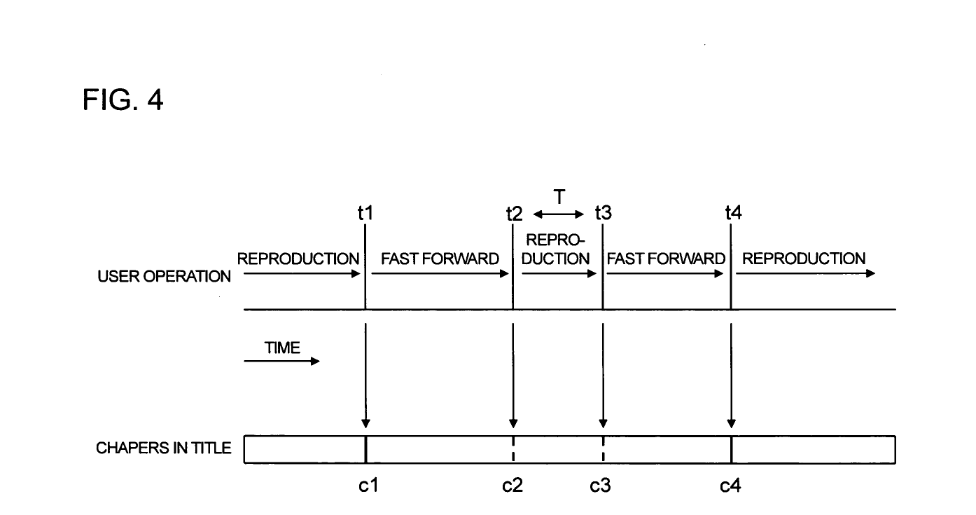

FIG. 4 is a timing diagram illustrating chapter setting processing of the second embodiment. A “user operation” chart indicates the timings of user operations where a user operates the operation section, and a “chapters in the title” chart indicates the timing of chapters set within title recorded to the optical disc or hard disk.

At the “user operation” chart, t1 indicates the time where a fast forward key of the operation section 20 (refer to FIG. 1) is pressed down during reproduction. t2 indicates a time where the reproduction key of the operation section 20 is pressed down during fast forward. t3 indicates a time where a fast forward key is pressed down during reproduction. t4 indicates a time where the reproduction key is pressed down during fast forward.

At the chart “chapters in the title”, c1 indicates a chapter set at the time t1 of the start of fast forward, c2 indicates a chapter set at the time t2 of the end of fast forward, c3 indicates a chapter set at the time t3 of the start of fast forward, and c4 indicates a chapter set at the time t4 of the end of fast forward. In the case of this example, when a time T (seconds) between the time t2 and the time t3 is shorter than a predetermined time t, chapters c2 and c3 are deleted.

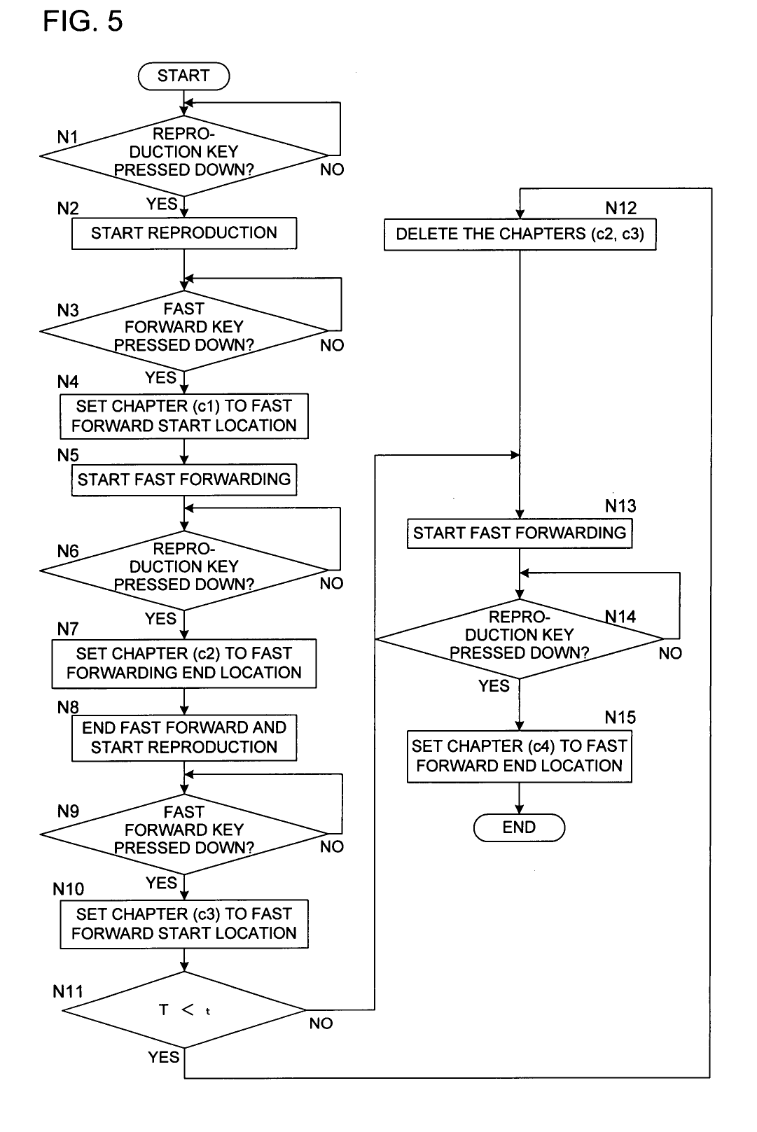

FIG. 5 is a flowchart illustrating chapter setting processing of the second embodiment. A description of a chapter setting process is now given with reference to this flowchart and to FIG. 1 and FIG. 4. A description is given here of processing for reproducing and setting chapters for information recorded on the optical disc 1. However, the same also applies for processing for reproducing and setting chapters for information recorded on the hard disk 3. In the following description, processing for the case where fast forward operations are carried out consecutively is described. However, the same processing is also carried out for the case of performing consecutive skip commercial operations.

The system controller 16 of the second embodiment is provided with a first chapter setting section for, at the time of a fast forward operation or skip commercial operation during reproduction of information recorded on a recording medium in the event that a chapter setting mode is effective, setting a chapter to a start location of this fast forward or the commercial start location, a second chapter setting section for, when fast forward is completed or commercial skipping is completed, setting a chapter to a fast forward end location or a skip commercial end location, a third chapter setting section for, when a fast forward operation or skip commercial operation is carried out again during reproduction after completion of the fast forward or after completion of skipping of a commercial, setting a chapter to the fast forward start location or the skip commercial start location, and a chapter deleting section for deleting both chapters when it is determined that reproduction time between the chapter set by the second chapter setting section and the chapter set by the third chapter setting section is shorter than a predetermined time.

When the reproduction key of the operation section 20 is pressed down when the chapter setting mode is effective, the system controller 16 detects pressing down of the reproduction key (step N1). The optical disc drive 2 is then made to reproduce, and reproduction of the optical disc 1 is commenced (step N2). During this reproduction, when the fast forward key of the operation section 20 is pressed down, the system controller 16 detects the pressing down of the fast forward key (step N3). Chapter c1 is then set to the location of the start of fast forward (step N4) by the first chapter setting section. Next, the optical disc drive 2 is put into fast forward, and fast forward is started for the optical disc 1 (step N5).

Next, when the reproduction key is pressed down, the system controller 16 detects the pressing down of the reproduction key (step N6). Chapter c2 is then set to the location of the end of fast forward (step N7) by the second chapter setting section. The system controller 16 then ends the fast forward operation and starts reproduction (step N8). After this, during this reproduction (during reproduction from time t2), when the fast forward key of the operation section 20 is pressed down, the system controller 16 detects the pressing down of the fast forward key (step N9). Chapter c3 is then set to the location of the start of fast forward (step N10) by the third chapter setting section. Next,

when the system controller 16 determines that reproduction time T between the chapter c2 set by the second chapter setting section and the chapter c3 set by the third chapter setting section is shorter than a predetermined time t (step N11), chapter c2 and chapter c3 constituting the chapters are deleted by the chapter deleting section (step N12). After this, the system controller 16 causes the optical disc drive 2 to perform a fast forward operation, and fast forwarding is started for the optical disc 1 (step N13). When the reproduction key is pressed down at time t4 (step N14), chapter c4 is set to the fast forward end location by the second chapter setting section (step N15).

According to this second embodiment, when the chapter setting mode is effective, it is possible to make chapters for information (moving pictures) recorded on recording media (the optical disc 1 or hard disk 3) automatically using operations (operations such as pausing, reproduction, stopping, commercial skipping, fast forward, fast reverse etc.) during viewing by a user (viewer). Further, when the fast forward operation or the skip commercial operation are consecutive, these sections are joined together to give one chapter. It is therefore possible for chapters to be set subconsciously in line with what the users themselves see as appropriate through operation in cooperation with user operations. Being able to make sections of consecutive fast forward operations or skip commercial operations a single chapter means that unnecessary chapters are not created and improves ease of use.

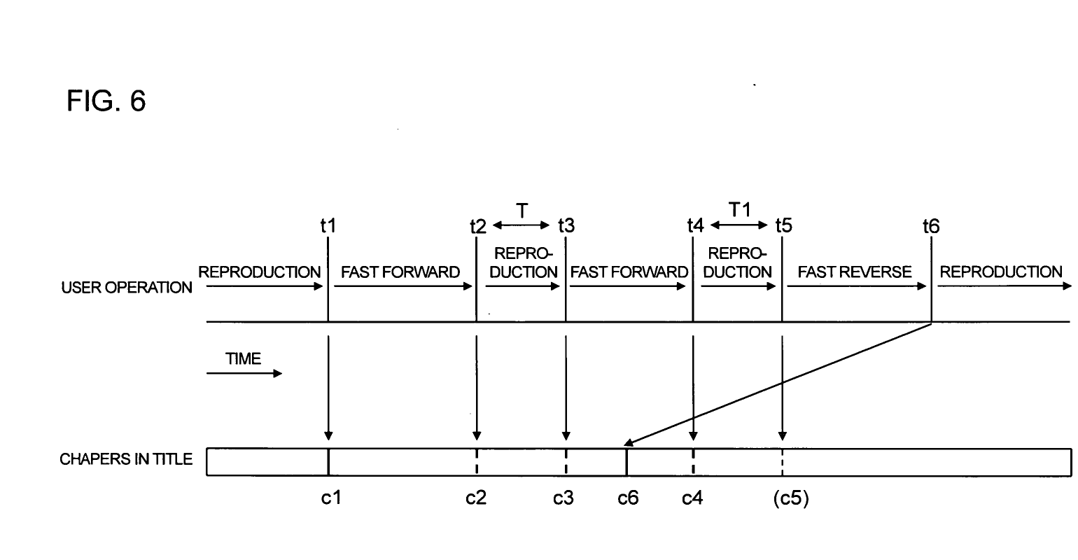

FIG. 6 is a timing diagram illustrating chapter setting processing of the third embodiment. A “user operation” chart indicates timing of user operations where a user operates the operation section, and a “chapters in the title” chart indicates the timing of chapters set within title recorded to the optical disc or the hard disk.

At the “user operation” chart, t1 indicates the time where a fast forward key of the operation section 20 (refer to FIG. 1) is pressed down during reproduction. t2 indicates a time where the reproduction key of the operation section 20 is pressed down during fast forward. t3 indicates a time where a fast forward key is pressed down during reproduction. t4 indicates a time where the reproduction key is pressed down during fast forward. t5 indicates a time where a fast reverse key is pressed down during reproduction. t6 indicates a time where the reproduction key is pressed down during fast reverse.

At the chart “chapters in the title”, c1 is taken to be a chapter set at the time t1 of the start of fast forward, c2 is taken to be a chapter set at the time t2 of the end of fast forward, c3 is taken to be a chapter set at the time t3 of the start of fast forward, c4 is taken to be a chapter set at the time t4 of the end of fast forward, and c5 is taken to be a virtual chapter that is a chapter that is not set at fast reverse start time t5. c6 indicates a chapter set at fast reverse end time t6. In the case of this example, when a time T (seconds) between the time t2 and the time t3 is shorter than the predetermined time t, chapters c2 and c3 are deleted. Further, when time T1 (seconds) between the time t4 and the time t5 is shorter than the predetermined time t, chapter c4 is deleted, and virtual chapter c5 also will not exist. The chapter c5 passed through in fast reverse is then deleted, and the virtual chapter c5 also will not exist.

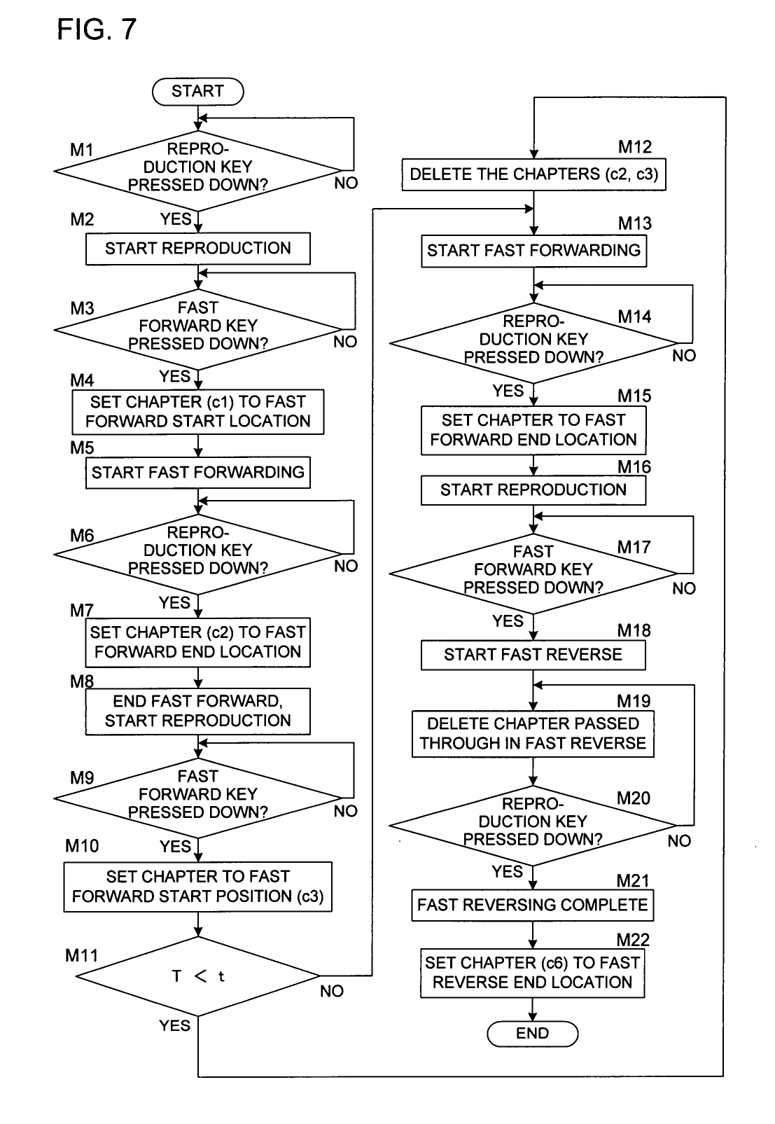

FIG. 7 is a flowchart illustrating chapter setting processing of the third embodiment. A description of a chapter setting process is now given with reference to this flowchart and to FIG. 1 and FIG. 6. A description is given here of processing for reproducing and setting chapters for information recorded on the optical disc 1. However, the same also applies for processing for reproducing and setting chapters for information recorded on the hard disk 3. In the following description, processing for the case where fast forward operations are carried out consecutively is described. However, the same processing is also carried out for the case of performing consecutive skip commercial operations.

The system controller 16 of the third embodiment is provided with a first chapter setting section for setting a chapter to a fast forward start location or a skip commercial start location at the time of a fast forward operation or skip commercial operation during reproduction of information recorded on a recording medium when a chapter setting mode is effective, a second chapter setting section for setting a chapter to a fast forward end location or a skip commercial end location when fast forwarding ends or when commercial skipping ends, a third chapter setting section for setting a chapter to a fast forward start location or a skip commercial start location at the time of a fast forward operation or a skip commercial operation during reproduction after completion of the fast forwarding or after completion of the commercial skipping, a chapter deleting section for deleting both chapters when it is determined that reproduction time between the chapter set by the second chapter setting section and the chapter set by the third chapter setting section is shorter than a predetermined time, a fast reverse chapter deleting section for deleting chapters passed through during fast reverse when a fast reverse operation is carried out, and a fast reverse chapter setting section for setting a chapter to a fast reverse end location.

When the reproduction key of the operation section 20 is pressed down when the chapter setting mode is effective, the system controller 16 detects pressing down of the reproduction key (step M1). The optical disc drive 2 is then made to reproduce, and reproduction of the optical disc 1 is commenced (step M2). During this reproduction, when the fast forward key of the operation section 20 is pressed down, the system controller 16 detects the pressing down of the fast forward key (step M3). Chapter c1 is then set to the location of the start of fast forward (step M4) by the first chapter setting section and fast forwarding starts for the optical disc 1 (step M5).

Next, when the reproduction key is pressed down, the system controller 16 detects the pressing down of the reproduction key (step M6). Chapter c2 is then set to the location of the end of fast forward (step M7) by the second chapter setting section. The system controller 16 then ends the fast forward operation and starts reproduction (step M8). After this, during this reproduction (during reproduction from time t2), when the fast forward key of the operation section 20 is pressed down, when the system controller 16 detects the pressing down of the fast forward key (step M9), chapter c3 is set to the location of the start of fast forward (step M10) by the third chapter setting section.

Next, when the system controller 16 determines that reproduction time T between the chapter c2 set by the second chapter setting section and the chapter c3 set by the third chapter setting section is shorter than the predetermined time t (step M11), chapter c2 and chapter c3 constituting the chapters are deleted by the chapter deleting section (step M12). After this, the system controller 16 causes the optical disc drive 2 to perform a fast forward operation, and fast forwarding is started for the optical disc 1 (step M13). When the reproduction key is pressed down at time t4 (step M14), chapter c4 is set to the fast forward end location by the fourth chapter setting section (step M15).

The system controller 16 then ends fast forwarding and starts reproduction (step M16). After this, the fast reverse key of the operation section 20 is pressed down during reproduction (during reproduction from time t4). The system controller 16 then detects pressing down of the fast reverse key (step M17). The optical disc drive 2 is then put into fast reverse, and fast reversing is started for the optical disc 1 (step M18). When fast reversing starts, the system controller 16 deletes the chapters c5 and c4 passed through in fast reverse (step M19). Here, chapter c5 is a virtual chapter that is not set to the time of starting fast reversing. When the reproduction key is pressed down at time t6 (step M20), the system controller 16 halts the fast reverse operation of the optical disc drive 2 and stops fast reversing of the optical disc 1 (step M21). Chapter c6 is then set to the fast reverse end location by the fast reverse chapter setting section (step M22).

According to this third embodiment, when the chapter setting mode is effective, it is possible to make chapters for information (moving pictures) recorded on recording media (optical disc 1 or hard disk 3) automatically using operations (operations such as pausing, reproduction, stopping, commercial skipping, fast forward, fast reverse etc.) during viewing by a user (viewer). Further, when the fast forward operation or the skip commercial operation are consecutive, these sections are joined together to give one chapter. When fast reversing is carried out after fast forwarding or commercial skipping, it is possible to erase chapter settings for up to the location that is reversed to. It is therefore possible for chapters to be set subconsciously in line with what the users themselves see as appropriate through operation in cooperation with user operations. It is also possible to make sections where fast forward operations or skip commercial operations are carried out consecutively into a single chapter. This means that skipping commercials etc. on the next viewing is made more straightforward, chapter setting positions can be reliably set, unnecessary chapters are not created, and ease of use is improved.

What is claimed is:

1. An information recording/reproducing apparatus which has a tuner for receiving and selecting a television broadcast signal, which records programs selected using the tuner or other information to a recording medium, and which has a chapter setting mode, the information recording/reproducing apparatus recording set chapter information to the recording medium or internally within the apparatus, and reproducing information recorded on the recording medium,
wherein the information recording/reproducing apparatus comprises a system controller that includes:
a chapter setting section for setting a chapter to a location corresponding to a time of changing of an operating state of the recording medium as a result of a user operation during reproduction of information recorded on the recording medium when the chapter setting mode is effective;
a fast reverse chapter deleting section for deleting chapters passed through in fast reverse; and
a fast reverse chapter setting section for setting a chapter to a fast reverse end location.

2. The information recording/reproducing apparatus according to claim 1, wherein the system controller includes:
a first chapter setting section for, when a pause operation is carried out during reproduction of the information recorded on the recording media, setting a chapter to a pause location;
a second chapter setting section for, when a skip commercial operation is carried out, setting a chapter to a skip commercial start location;
a third chapter setting section for, when skipping started by the skip commercial operation is complete, setting a chapter to a skip end location;
a fourth chapter setting section for, when a fast forward operation is carried out, setting a chapter to a fast forward start location;
a fifth chapter setting section for, when an operation to stop fast forwarding is carried out, setting a chapter to a fast forward end location;
a fast reverse chapter deleting section for, when fast reversing is carried out, deleting chapters passed through in fast reverse; and
a fast reverse chapter setting section for, when an operation to stop fast reversing is carried out, setting a chapter to a fast reverse end location.

3. An information recording/reproducing apparatus which has a tuner for receiving and selecting a television broadcast signal, which records programs selected using the tuner or other information to a recording medium, and which has a chapter setting mode, the information recording/reproducing apparatus recording set chapter information to the recording medium or internally within the apparatus and reproducing information recorded on the recording medium,
wherein the information recording/reproducing apparatus comprises a system controller that includes:
a chapter setting section for setting a chapter to a location corresponding to a time of changing of an operating state of the recording medium as a result of a user operation during reproduction of information recorded on the recording medium when the chapter setting mode is effective; and
a chapter deleting section for, when it is determined that reproduction time between a chapter set to a fast forward end location or a skip commercial end location and a chapter set to a next fast forward start location or a next skip commercial start location is shorter than a predetermined time, deleting both of the chapters.

4. The information recording/reproducing apparatus according to claim 3,
wherein the system controller includes:
a first chapter setting section for, when fast forwarding or commercial skipping takes place during reproduction of the information recorded on the recording medium, setting a chapter to a fast forward start location or a skip commercial start location;
a second chapter setting section for, when the fast forwarding is complete, or when the commercial skipping is complete, setting a chapter to a fast forward end location or a skip commercial end location;
a third chapter setting section for, when fast forwarding or the commercial skipping is carried out again during reproduction after completion of the fast forwarding or after completion of the commercial skipping, setting a chapter to a fast forward start location or a skip commercial start location; and
a chapter deleting section for, when it is determined that reproduction time between the chapter set by the second chapter setting section and the chapter set by the third chapter setting section is shorter than a predetermined time, deleting both of the chapters.

5. An information recording/reproducing apparatus which has a tuner for receiving and selecting a television broadcast signal, which records programs selected using the tuner or other information to a recording medium, and which has a chapter setting mode, the information recording/reproducing apparatus recording set chapter information to the recording medium or internally within the apparatus and reproducing information recorded on the recording medium,
wherein the information recording/reproducing apparatus comprises a system controller that includes:
a chapter setting section for setting a chapter to a location corresponding to a time of changing of an operating state of the recording medium as a result of a user operation during reproduction of information recorded on the recording medium when the chapter setting mode is effective;
a chapter deleting section for, when it is determined that reproduction time between a chapter set to a fast forward end location or a skip commercial end location and a chapter set to a next fast forward start location or a next skip commercial start location is shorter than a predetermined time, deleting both of the chapters;
a fast reverse chapter deleting section for, when fast reversing is carried out, deleting chapters passed through during the fast reversing; and
a fast reverse chapter setting section for setting a chapter to a fast reverse end location.

6. The information recording/reproducing apparatus according to claim 5,
wherein the system controller includes:
a first chapter setting section for, when fast forwarding or commercial skipping takes place during reproduction of the information recorded on the recording medium, setting a chapter to a fast forward start location or a skip commercial start location;
a second chapter setting section for, when the fast forwarding is complete, or when the commercial skipping is complete, setting a chapter to a fast forward end location or a skip commercial end location;
a third chapter setting section for, when fast forwarding or commercial skipping is carried out again during reproduction after completion of fast forwarding or after completion of the commercial skipping, setting a chapter to a fast forward start location or a skip commercial start location;
a chapter deleting section for, when it is determined that reproduction time between the chapter set by the second chapter setting section and the chapter set by the third chapter setting section is shorter than a predetermined time, deleting both of the chapters;
a fast reverse chapter deleting section for, when fast reversing is carried out, deleting chapters passed through during the fast reversing; and
a fast reverse chapter setting section for setting a chapter to a fast reverse end location.
